(19) United States
(12) Patent Application Publication
(10) Pub. No.: US 2015/0266680 A1
(43) Pub. Date: Sep. 24, 2015

(54) MATERIAL TRIAGE SYSTEM FOR WORKSITE

(71) Applicant: Caterpillar Inc., Peoria, IL (US)

(72) Inventors: James D. Humphrey, Decatur, IL (US); Rod A. Pool, Pleasant Plains, IL (US)

(73) Assignee: Caterpillar Inc., Peoria, IL (US)

(21) Appl. No.: 14/729,076

(22) Filed: Jun. 3, 2015

(51) Int. Cl. B65G 65/32; B65G 67/24

(52) U.S. Cl. CPC B65G 65/32; B65G 67/24

(57) ABSTRACT

A material triage system for material dump operation via a hauling machine is disclosed. The material triage system includes a dump facility and a runway platform. The dump facility is configured to receive material dumped by the hauling machine. The runway platform allows the hauling machine to dump the material into the dump facility. The runway platform includes an entry platform with a first end and an exit platform with an engaging end that is proximal to the entry platform. The runway platform further includes a door assembly, which is positioned between the entry platform and the exit platform. The door assembly is pivotably connected about the first end of the entry platform, between an open position and a closed position, with respect to the engaging end of the exit platform. The door assembly includes a door and a counterweight attached to the door.

### TECHNICAL FIELD

The present disclosure relates to dump operations performed in a worksite via a hauling machine. More particularly, the present disclosure relates to a material triage system for material dump operations with a reduced unloading time per cycle.

### BACKGROUND

Machines, such as haul trucks, loaders, mining trucks, and other types of heavy machinery, may be used to perform a variety of tasks. In a worksite, such as a mining site or excavation site, the machines may be used to load excavated or extracted material. The loaded material may be carried to a location where a crusher is positioned. The material may be dumped and delivered to a hopper of the crusher. The material from the hopper of the crusher may be then conveyed to be crushed by an auger or similar mechanism, via a conveyer system. However, for dump of the material in the hopper, the machine may be required to drive to a hopper location. Thereafter, the machine is reversed such that a carrier body of the machine faces the hopper. Further, the machine is required to be positioned in an efficient manner near the hopper, such that minimal or no material falls on a platform of the crusher. However, the reversing of the machine and thereafter, optimum positioning of the machine near the hopper may add a delay while unloading the material per dump cycle. Further, in case of the machines, such as autonomous dump trucks, the delay per load cycle may be more than one minute.

Hence, there is scope for improvement in the dump operation at mining sites or excavation sites. In such cases, delay per load cycle is reduced to accommodate more load cycles in a given time. The present disclosure is directed at solving one or more of the above-mentioned problems.

### SUMMARY OF THE INVENTION

Various aspects of the present disclosure relate to a material triage system for a worksite, via a hauling machine. The material triage system includes a dump facility and a runway platform. The dump facility is configured to receive a load dumped by the hauling machine. The runway platform is disposed proximal to the dump facility. The runway platform is configured to allow the hauling machine to dump the load into the dump facility. The runway platform includes an entry platform, an exit platform, and a door assembly. The entry platform includes a first end. The exit platform includes an engaging end, which is proximal to the entry platform. The door assembly is positioned between the entry platform and the exit platform. An opening is defined between the entry platform and the exit platform, to deliver the load to the dump facility. The door assembly is pivotably connected about the first end of the entry platform. The door assembly is operable in an open position and a closed position with respect to the engaging end of the exit platform. The door assembly includes a door and a counterweight. The door includes a connecting end, a pivotal edge, and a free end. The pivotal edge is pivotably coupled to the first end of the entry platform. The counterweight is attached to the connecting end of the door. The counterweight is configured to maintain the door in the open position in absence of the hauling machine on the door. While the hauling machine moves in a dump direction, the door is configured to be in the closed position in a presence of the hauling machine on the door. In the closed position, the door bears a combined load of the weight of the hauling machine and the counterweight. This causes an engagement of the free end of the door with the engaging end of the exit platform.

### BRIEF DESCRIPTION OF THE DRAWINGS

FIG. 1 is a perspective view of a worksite, where a hauling machine approaches a door of a runway platform, in accordance with the concepts of the present disclosure;

FIG. 2 is an enlarged side view of the runway platform of FIG. 1, illustrating the hauling machine proximal to the door, in accordance with the concepts of the present disclosure;

FIG. 3 is a perspective view of the worksite of FIG. 1, where the hauling machine is over the door of the runway platform, in accordance with the concepts of the present disclosure;

FIG. 4 is an enlarged side view of the runway platform of FIG. 3, illustrating the hauling machine positioned over the door, in accordance with the concepts of the present disclosure; and

FIG. 5 is a perspective view of the worksite of FIG. 1, wherein the hauling machine rests against a wheel stopper portion of the runway platform to dump material, in accordance with the concepts of the present disclosure.

### DETAILED DESCRIPTION

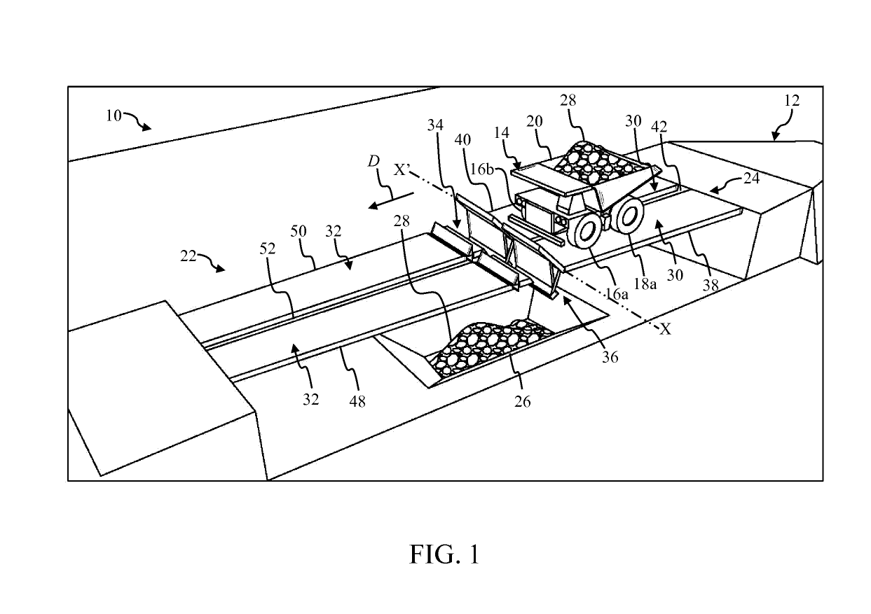

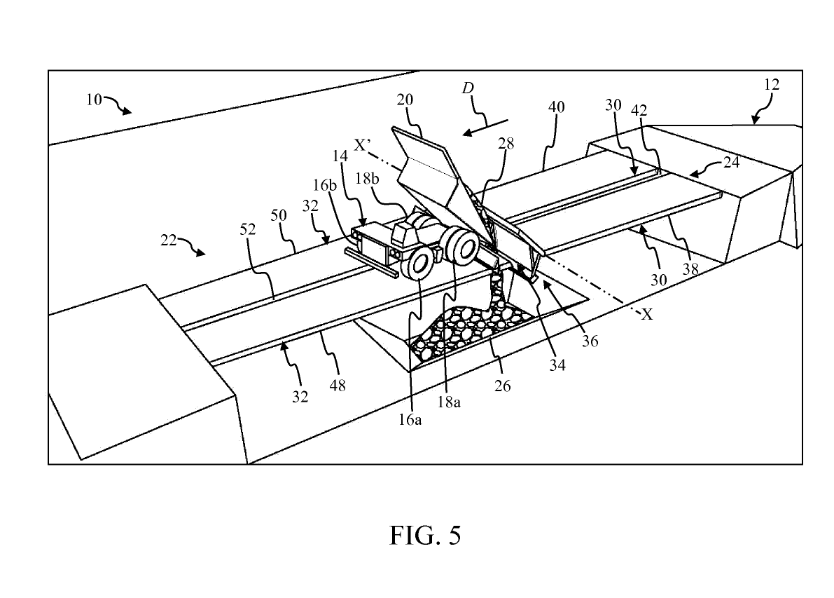

Referring to FIG. 1, there is shown a perspective view of a worksite 10, with a crusher 12 and a hauling machine 14. A first phase of a method of a material dump operation, performed by the hauling machine 14, is shown. In the first phase of the material dump operation, the hauling machine 14 arrives at the worksite 10 or the dump location. The hauling machine 14 may be a dump truck, a mining truck, and/or the like. The hauling machine 14 includes a pair of front wheels 16a, 16b, a pair of rear wheels 18a, 18b (FIG. 5), and a carrier body 20.

The crusher 12 is equipped with a material triage system 22 for the material dump operation. The material triage system 22 includes a runway platform 24 and a dump facility 26. The runway platform 24 is structured to facilitate drive through of the hauling machine 14. Drive through of the hauling machine 14 is necessary when the hauling machine 14 carrying material 28 to the worksite 10 to transfer load to the dump facility 26. The dump facility 26 is in proximity of the runway platform 24. In the illustrated embodiment, the dump facility 26 is placed beneath the runway platform 24.

The runway platform 24 includes an entry platform 30, an exit platform 32, an opening 34, and a door assembly 36. The entry platform 30 is aligned along a plane of the exit platform 32. In an exemplary embodiment, a width of the entry platform 30 is equal to a width of the exit platform 32. In an embodiment, the width of the entry platform 30 may be more or less than the width of the exit platform 32. In the illustrated embodiment, the entry platform 30 is divided into a first longitudinal portion 38 and a second longitudinal portion 40, which run along a length of the entry platform 30. The first longitudinal portion 38 and the second longitudinal portion 40 define a gap 42, which runs along the length of the entry platform 30. The structure of the entry platform 30 is such that the front wheel 16a and the rear wheel 18a travel on the first longitudinal portion 38. The front wheel 16b and the rear wheel 18b (refer to FIG. 5) travel on the second longitudinal portion 40. The first longitudinal portion 38 and the second longitudinal portion 40 of the entry platform 30 include first ends 44, 46. The first ends 44, 46 of the first longitudinal portion 38 and the second longitudinal portion 40, are structured to facilitate attachment of the door assembly 36.

The exit platform 32 is positioned at a certain distance from the entry platform 30 to define the opening 34. The opening 34 facilitates a way for transfer of the material 28 in the dump facility 26. In the illustrated embodiment, the exit platform 32 is divided into a first longitudinal portion 48 and a second longitudinal portion 50, which run along a length of the exit platform 32. The first longitudinal portion 48 and the second longitudinal portion 50 define a gap 52, which runs along the length of the exit platform 32. The structure of the exit platform 32 is such that the front wheel 16a and the rear wheel 18a move on the first longitudinal portion 48. The front wheel 16b and the rear wheel 18b (FIG. 5) travel on the second longitudinal portion 50.

In other embodiment, the entry platform 30 and the exit platform 32 may be unitary platforms without any gap therebetween, or made of multiple longitudinal portions parallel to each other, or grid type driveways, running along the length of the runway platform 24. In an embodiment, the entry platform 30 and the exit platform 32 may be a single or multi-lane driveways, which may be made up of steel, asphalt, concrete and/or wood. This disclosure does not limit the use of different types, materials, sizes and shapes of platforms 30, 32.

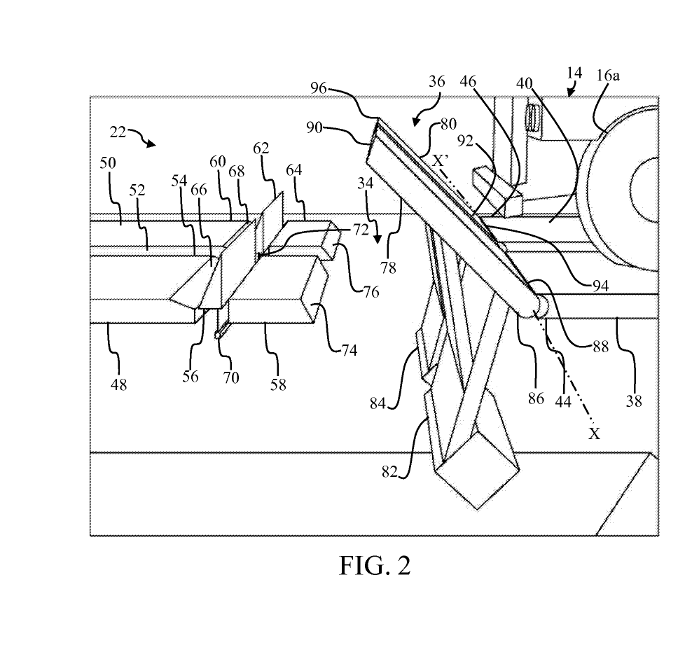

Referring to FIG. 2, there is shown a close-up view of the entry platform 30, the exit platform 32, and the door assembly 36. The first longitudinal portion 48 includes a first portion 54, a first wheel stopper portion 56, and a first engaging end 58. The second longitudinal portion 50 of the exit platform 32 includes a first portion 60, a second wheel stopper portion 62, and a second engaging end 64. The first portions 54, 60 of the exit platform 32, respectively, are in-line to the first ends 44, 46 of the entry platform 30. The first portion 54 includes a first slanting edge 66. The first portion 60 includes a second slanting edge 68. The first portions 54, 60 are attached to the wheel stopper portions 56, 62, respectively, which in turn are attached to the engaging ends 58, 64. The wheel stopper portions 56, 62 are wedge-shaped structures, which are positioned proximal to the engaging ends 58, 64. The wheel stopper portions 56, 62 restrict the hauling machine 14 from backward movement towards the opening 34. The wheel stopper portions 56, 62, respectively, are provided with counterweights 70, 72 at an underside of the wheel stopper portions 56, 62. The counterweights 70, 72, respectively, are attached to base portions of the wheel stopper portions 56, 62, and are directed towards the dump facility 26. The engaging ends 58, 64 are directed towards the opening 34 and are aligned along the plane of the exit platform 32. The first engaging end 58 includes a first inclined end 74. The second engaging end 64 includes a second inclined end 76.

The door assembly 36 is positioned between the entry platform 30 and the exit platform 32. The door assembly 36 pivotably connected about the first ends 44, 46 of the entry platform 30. The door assembly 36 is operable in an open position and a closed position with respect to the engaging end of the exit platform 32. The door assembly 36 includes a first door 78, a second door 80, a first counterweight 82, and a second counterweight 84. The first door 78 and the second door 80 are operable between the closed position and the open position. The open position of the first door 78 and the second door 80, are is shown in FIG. 2, in an enlarged view of the door assembly 36 and the runway platform 24. The first door 78 and the second door 80 are moveable to cover and uncover the opening 34. The first door 78 and the second door 80, respectively, have a width equal to the width of the first longitudinal portion 48 and the second longitudinal portion 50. The first door 78 is attached to the first end 44 of the first longitudinal portion 48, such that the first door 78 pivots about an axis X-X′. The second door 80 is attached to the first end 46 of the second longitudinal portion 50, such the second door 80 pivots about the axis X-X′. The first door 78 includes a first connecting end 86, a first pivotal edge 88, and a first free end 90. The second door 80 includes a second connecting end 92, a second pivotal edge 94, and a second free end 96. The pivotal edges 88, 94, respectively, are pivotably coupled to the first ends 44, 46 of the entry platform 30. The free ends 90, 96 include a structure such that the free ends 90, 96, respectively engage with the inclined ends 74, 76 of the exit platform 32, when the position of the doors 78, 80 is closed. In the closed position, the doors 78, 80 covers the opening 34 of the runway platform 24, via an engagement of the free ends 90, 96, respectively, with the inclined ends 74, 76 of the exit platform 32. In the open position, the doors 78, 80 are oriented at a predetermined angle relative to plane of the runway platform 24. This uncovers the opening 34 of the runway platform 24. The opening 34 is uncovered for receipt of the material 28 unloaded by the hauling machine 14.

In addition, the open position, and the closed position of the doors 78, 80 are attained by action of the counterweights 82, 84. The first counterweight 82 is attached to the first connecting end 86 of the first door 78. The second counterweight 84 is attached to the second connecting end 92 of the second door 80. The counterweights 82, 84 are configured to maintain the doors 78, 80 in the open position in absence of the hauling machine 14 over the doors 78, 80. In addition, the doors 78, 80 remain in the closed position under the presence of the hauling machine 14 on the doors 78, 80. This results from a combined load of the weight of the hauling machine 14 and the counterweights 82, 84. This causes an engagement of the free ends 90, 96 of the doors 78, 80 with the engaging ends 58, 64 of the exit platform 32. In an embodiment, the counterweights 82, 84 may be a spring load, a pulley, and/or others known in the art.

In the open position of the door, the material 28 is dumped in the dump facility 26. The dump facility 26 may be a tray used to receive the material 28 dumped by the hauling machine 14. In an embodiment, the dump facility 26 may include a material transfer unit such that the material 28 from the dump facility 26 is transferred to the crusher 12 or other ordinarily known material crushing equipment such as an auger (not shown). The material transfer unit may be a conveyor belt, screw type conveyor, and/or the like. The material transfer unit is configured to receive the material 28 from the hauling machine 14, and to convey the received material 28 to a crushing mechanism (not shown). The crushing mechanism (not shown) is provided to crush to required forms and sizes.

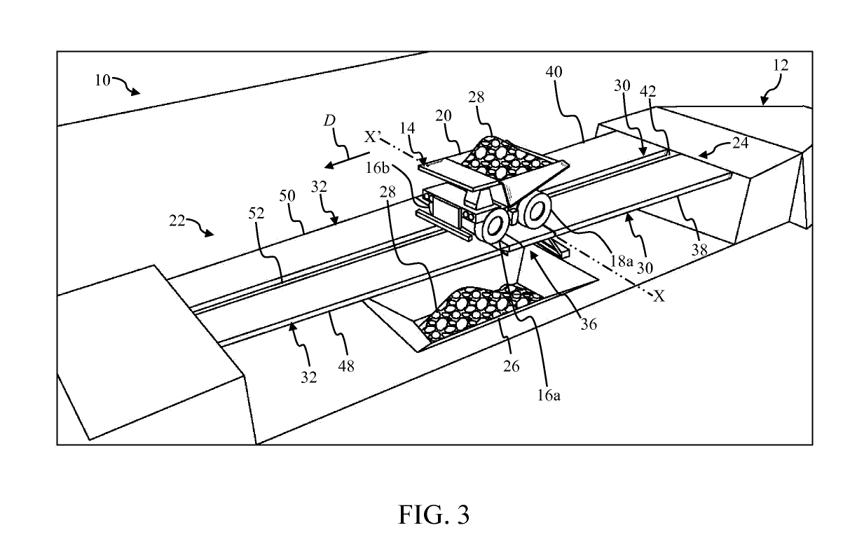

Referring to FIG. 3, there is shown a second phase of the method of the material dump operation performed by the hauling machine 14. In the second phase, the hauling machine 14 moves in the dump direction, D on the runway platform 24. While proceeding in the dump direction, D, the hauling machine 14 moves over the doors 78, 80 that are inclined at the pre-determined angle. The wheels on the first side of the hauling machine 14 move over the first door 78. The wheels on the second side of the hauling machine 14 move over the second door 80. As the hauling machine 14 moves further over the doors 78, 80, the doors 78, 80 move towards the inclined ends 74, 76 of the exit platform 32. This is done to attain the closed position, and thus covers the opening 34 of the runway platform 24. The doors 78, 80, are in the closed position via an engagement of the free ends 90, 96 of the doors 78, 80 with the inclined ends 74, 76 of the exit platform 32, when the hauling machine 14 is completely over the doors 78, 80. The doors 78, 80 are maintained in the closed position due to the combined load of the weight of the hauling machine 14 and the counterweights 82, 84.

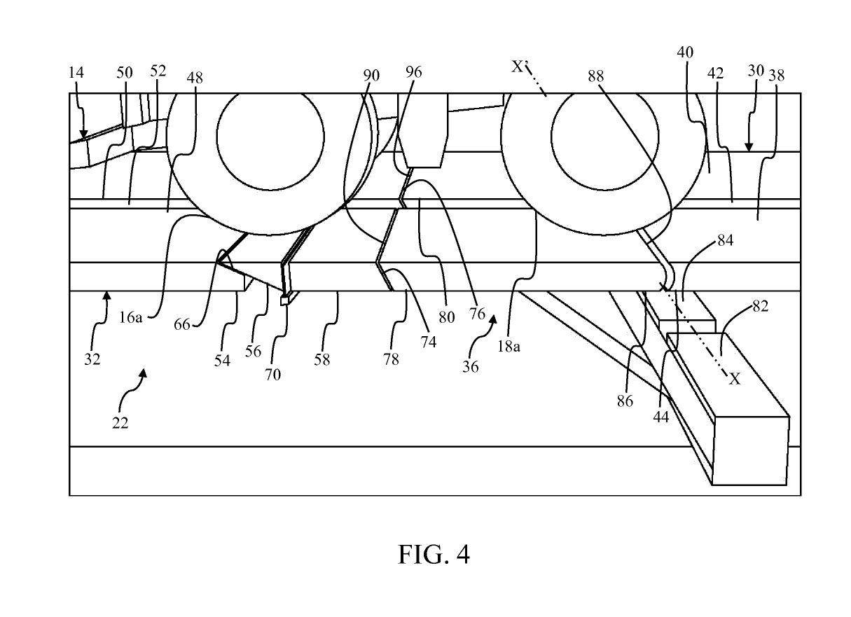

Referring to FIG. 4, there is shown a close view of the door assembly 36, in the closed position, with the hauling machine 14 and the runway platform 24. Upon closure of the doors 78, 80 against the engaging ends 58, 64, the rear wheel 18a and the rear wheel 18b (FIG. 5) proceed towards the wheel stopper portions 56, 62. This results in pivoting of the wheel stopper portions 56, 62, to engage with the slanting edges 66, 68 of the exit platform 32.

Referring to FIG. 5, there is shown a third phase of the method of the material dump operation performed by the hauling machine 14. In the third phase, the hauling machine 14 moves in the dump direction, D. Thus, the hauling machine 14 moves away from the doors 78, 80, the engaging ends 58, 64, and the wheel stopper portions 56, 62, while moving towards the exit platform 32. When the hauling machine 14 is no longer over the doors 78, 80, the doors 78, 80 raise back to retain the open position (due to counterweight 82, 84) to uncover the opening 34 in the runway platform 24. This results from a disengagement of the free ends 90, 96 of the doors 78, 80, respectively, with the inclined ends 74, 76 of the exit platform 32. Also, when the hauling machine 14 is no longer over the wheel stopper portions 56, 62, the wheel stopper portions 56, 62 pivot to attain an upright position. The upright position of the wheel stopper portions 56, 62 is maintained via the counterweights 70, 72. The upright position of the wheel stopper portions 56, 62 helps to restrict movement of the rear wheels 18a, 18b of the hauling machine 14, towards the opening 34. The hauling machine 14 is hence retained on the exit platform 32, proximal to the opening 34, to facilitate the dump operation.

### INDUSTRIAL APPLICABILITY

In operation, the hauling machine 14 travels to the worksite 10 to deliver the material 28 to the dump facility 26. The disclosed material triage system 22 for the material dump operation allows the hauling machine 14 to dump the material 28 while the hauling machine 14 passes through the runway platform 24, without reversing. In the material dump operation, when the hauling machine 14 is not positioned over or passing over the doors 78, 80, the doors 78, 80 will remain in the open position. The hauling machine 14 travels over the entry platform 30, and moves towards the opening 34. As the wheels of the hauling machine 14 move over the doors 78, 80, the doors 78, 80 pivot and attain the closed position by resting against the inclined ends 74, 76 of the exit platform 32. This provides the way to the exit platform 32, by covering the opening 34. The hauling machine 14 travels over the doors 78, 80, and moves towards the exit platform 32. Upon passing over the doors 78, 80, the hauling machine 14 stops over the exit platform 32, such that the rear wheels 18a, 18b, rest against the wheel stopper portions 56, 62. On attaining of a stable position over the exit platform 32, the hauling machine 14 raises the carrier body 20 towards the opening 34, to dump the material 28 into the dump facility 26. Upon completion of the material dump operation, the hauling machine 14 moves away from the exit platform 32 and hence, exits the worksite 10.

The disclosed material triage system 22 provides an advantage over the conventional dumping systems of a worksite, as there is no requirement of reverse of the hauling machine 14 to unload the material 28 into the dump facility 26. The proposed material triage system 22 and method of the material dump operation allows the hauling machine 14 to deliver the material 28 to the dump facility 26, via the opening 34. Upon dump of the material 28, the hauling machine 14 travels in the same direction as the dump direction, D and exits the runway platform 24. This results in reduction in time taken by the hauling machine 14, per cycle of the material dump operation. Hence, the proposed material triage system 22 and the method are economical and convenient.

The many features and advantages of the disclosure are apparent from the detailed specification, and thus, it is intended by the appended claims to cover all such features and advantages of the disclosure, which fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A material triage system for a worksite, the worksite accommodating material movement via a hauling machine, the material triage system comprising:
a dump facility configured to receive material unloaded by the hauling machine;
a runway platform configured to allow the hauling machine to pass over to eject the material into the dump facility, the runway platform including:
an entry platform having a first end;
an exit platform with an engaging end which is proximal to the entry platform;
a door assembly positioned between the entry platform and the exit platform thereby defining an opening for delivering the material to the dump facility, the door assembly pivotably connected about the first end of the entry platform, wherein the door assembly being operable to move between an open position and a closed position with respect to the engaging end of the exit platform, the door assembly including:
a door having a connecting end, a pivotal edge and a free end, wherein the pivotal edge is pivotably coupled to the first end of the entry platform; and
a counterweight being attached to the connecting end of the door,
wherein the counterweight is configured to maintain the door in the open position when the hauling machine is not positioned on the door and hauling machine,
wherein while the hauling machine moves in a dump direction, the door being configured to close under a presence of the hauling machine on the door.
